(19) United States
(12) Patent Application Publication
(10) Pub. No.: US 2017/0239968 A1
(43) Pub. Date: Aug. 24, 2017

(54) METHOD AND APPARATUS FOR PRINTING IMAGES ON IRREGULAR SURFACES WITH DYE SUBLIMATION

(71) Applicant: Caretek, Inc., Denver, CO (US)

(72) Inventor: Daniel GREENE, Denver, CO (US)

(21) Appl. No.: 15/439,930

(22) Filed: Feb. 22, 2017

Related U.S. Application Data
(60) Provisional application No. 62/298,733, filed on Feb. 23, 2016.

(51) Int. Cl. B41M 5/00; B41M 5/382

(52) U.S. Cl. CPC B41M 5/0094; B41M 5/0052; B41M 5/007; B41M 5/38221

(57) ABSTRACT

The present disclosure provides an apparatus for printing an image on a substrate with an irregular surface using dye sublimation, the apparatus comprising: an autoclavable envelope bag comprising a sealable opening and a first port; a breather material to hold in place a paper carrying colorants forming the image on the irregular surface; a hollow metal receptacle comprising a second port that connects with the first port on the autoclavable envelope bag, a third port that connects to a vacuum pump, and a valve that opens and closes the third port; and a vacuum pump with a tube that connects with the third port on the hollow metal receptacle. Also provided is a method of printing an image on a substrate with an irregular surface using dye sublimation with the disclosed apparatus.

### CROSS REFERENCE TO RELATED APPLICATIONS

This application claims priority to U.S. Provisional Application No. 62/298,733 filed Feb. 23, 2016, the contents of which are incorporated herein by reference in their entirety.

### FIELD

The present disclosure relates to a method of transferring a digital image to a solid substrate using dye sublimation

### BACKGROUND

Dye sublimation involves first imparting an image or decorative design on a dyestuff (i.e., dye carrier) with sublimation inks. The image or decorative design is typically imparted on the dyestuff by an inkjet or a laser printer. After the image is imparted on the dyestuff, a manufacturer places the dyestuff on the substrate (object on which the image is to be printed). There are a number of different ways that the manufacturer can then sublimate the dye into the given substrate.

In one conventional example, the manufacturer places the assembly into an oven, and heats the assembly above the sublimation temperature of the dye and the glass transition temperature (Tg) of the substrate. In this case, the manufacturer positions the assembly so that the oven's heat source provides heat directly to the side of the substrate to be decorated (i.e., via dye sublimation). In most if not all cases, the manufacturer also applies continuous pressure. Once the dye reaches its sublimation temperature and the substrate has reached its Tg, the dye infuses into the substrate, thus importing the intended image to the substrate. Thereafter, the manufacturer cools the assembly to a temperature below the Tg of the substrate.

In another process, the manufacturer uses vacuum bags, envelope bags, or the like to aid in the distribution of pressure. For example, the manufacturer may place the dyestuff and substrate assembly into a vacuum bag or envelope bag. Similarly, a manufacturer can position a substrate and dyestuff within a pliable covering membrane that has dimensions greater than the substrate. In both cases, the manufacturer can then evacuate the air from the assembly and apply pressure to the substrate and dyestuff.

During heating of the substrate and dyestuff, the pressure within the vacuum bag or envelope bag may decrease as the increasing kinetic energy of the air in the bag causes it to expand and increase in volume. This can be problematic because close contact between the dyestuff and the substrate is required for efficient transfer of the colorants during dye sublimation. There is a need to provide an apparatus and process for transferring an image onto a substrate with an irregular surface using dye sublimation wherein constant pressure is maintained during the heating of the dyestuff or colorants and the substrate.

### BRIEF DESCRIPTION OF THE DRAWINGS

FIG. 1 depicts an embodiment of the envelope bag and the hollow metal receptacle used to maintain a vacuum within the envelope bag during autoclaving or heating.

FIG. 2A depicts the sealable opening of the envelope bag into which a substrate with an irregular surface is inserted. FIG. 2B depicts a glass plate with an irregular surface onto which an image may be transferred with the process disclosed herein.

FIG. 3A depicts a glass plate with an irregular surface inside the envelope bag with a paper substrate having an image printed thereon. The image is face down against the upper surface of the glass plate. FIG. 3B depicts a breather material that is laid over the glass plate and paper substrate with the image. The breather material holds the paper in place during the application of the vacuum and prevents any wrinkling of the paper substrate.

FIG. 4 depicts a vacuum pump connected by a tube to the hollow metal receptacle and envelope bag. The vacuum pump is applied through the metal container to the sealed envelope bag. A valve indicated in FIG. 1 and also shown in FIG. 4 is closed after the vacuum pressure is applied to create a closed system within the metal container and the envelope bag.

FIG. 5A depicts an envelope bag containing a glass plate, paper substrate with an image printed thereon, and breather material covering the paper substrate. The envelope bag is shown entering an oven after vacuum pressure has been applied. The heat from the oven causes the ink from the image on the paper substrate to transfer to the glass plate and form a permanent image on the glass. FIG. 5B depicts the glass plate after heating and cooling with the permanent image transferred from the paper substrate.

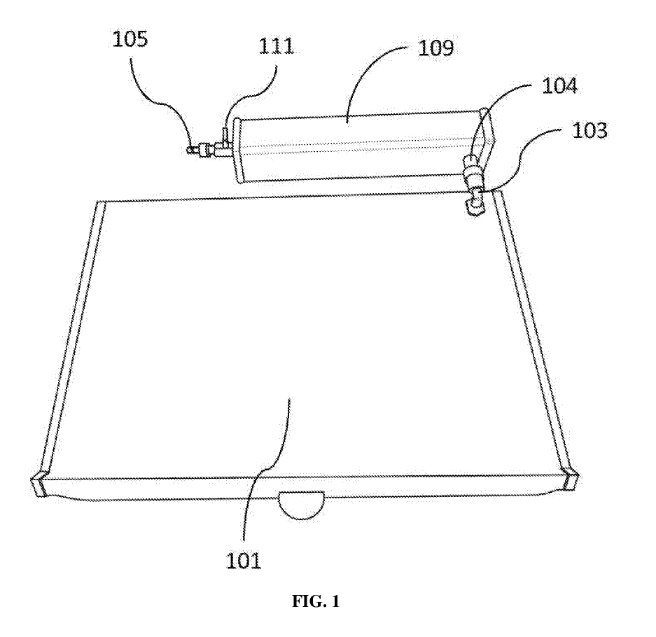

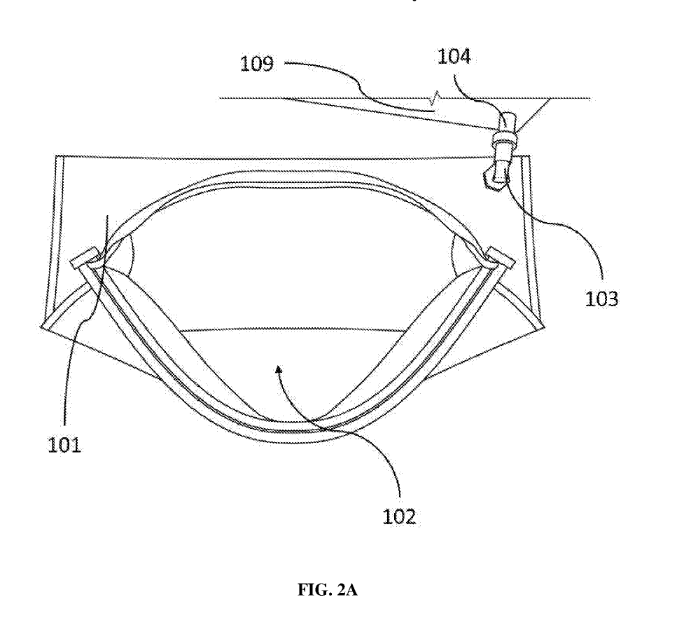

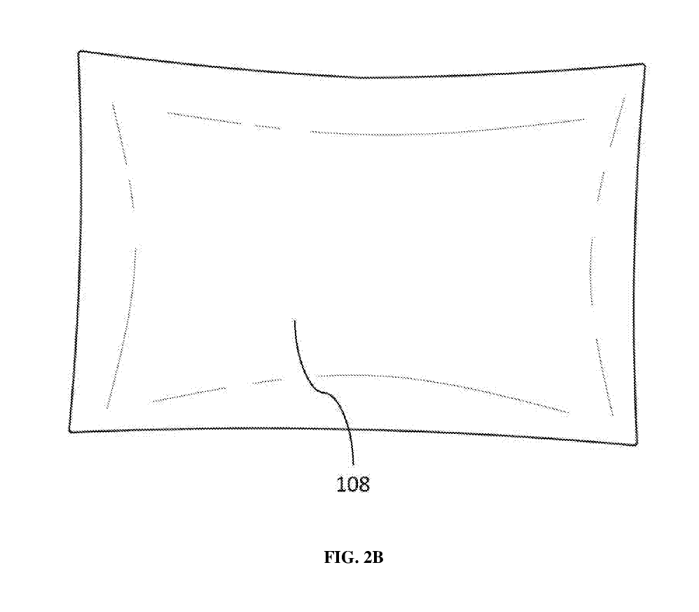

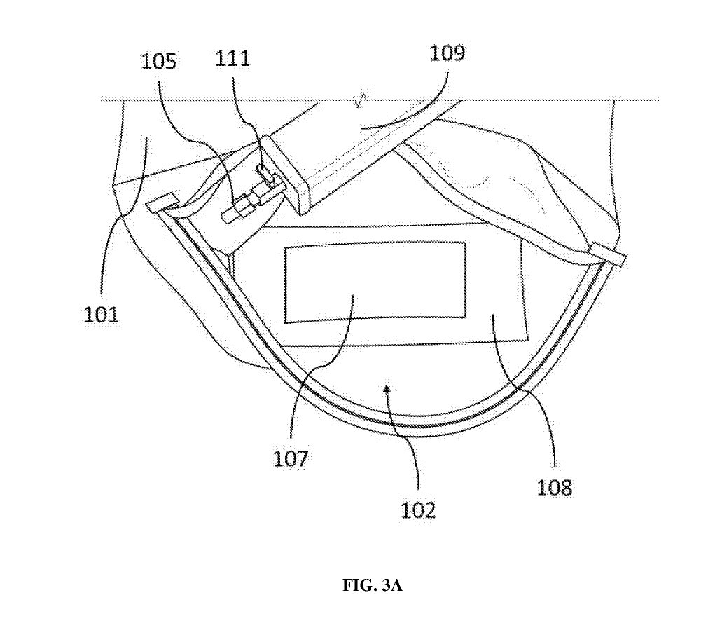

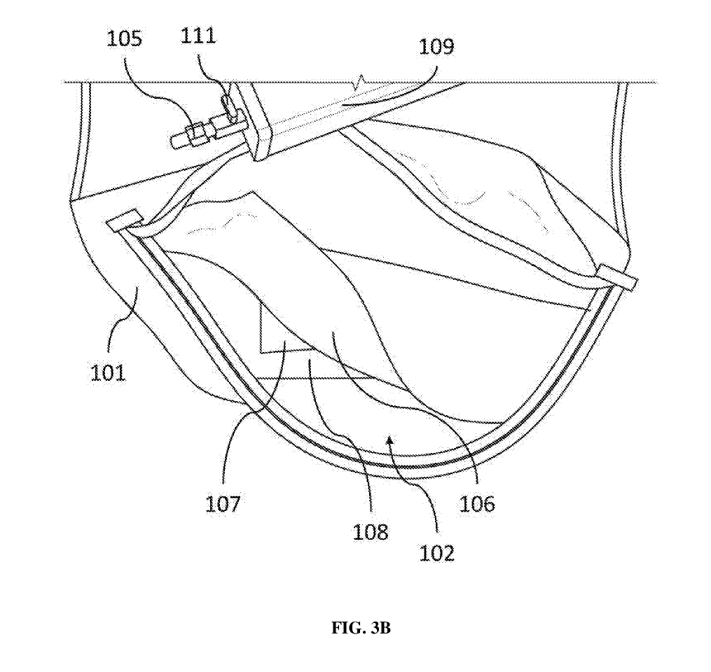

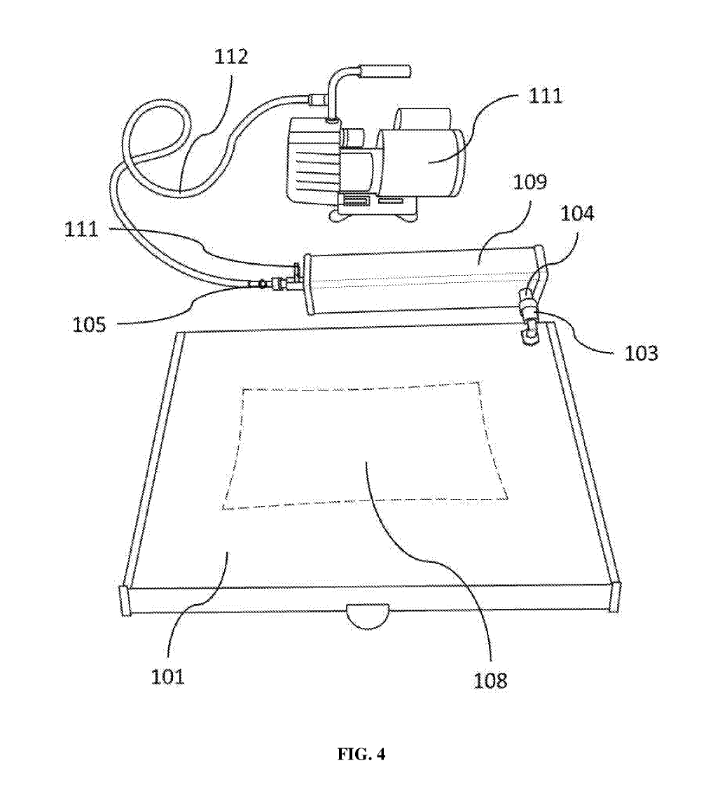

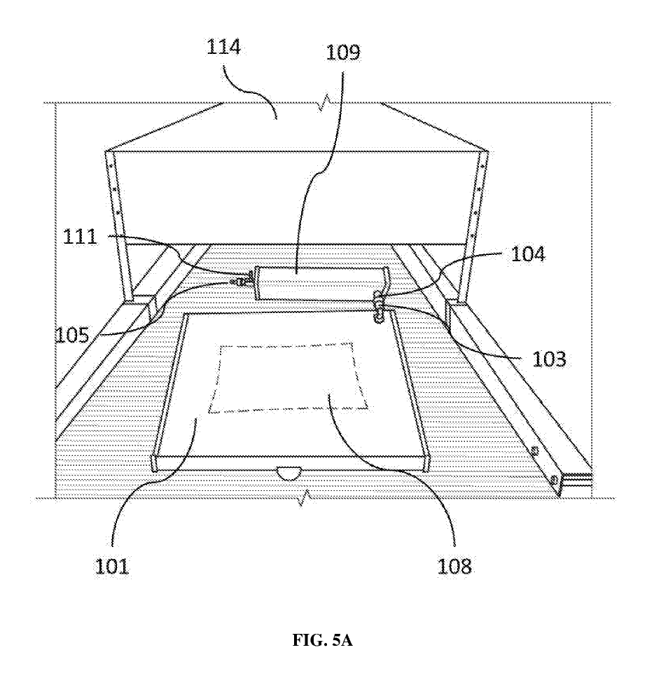

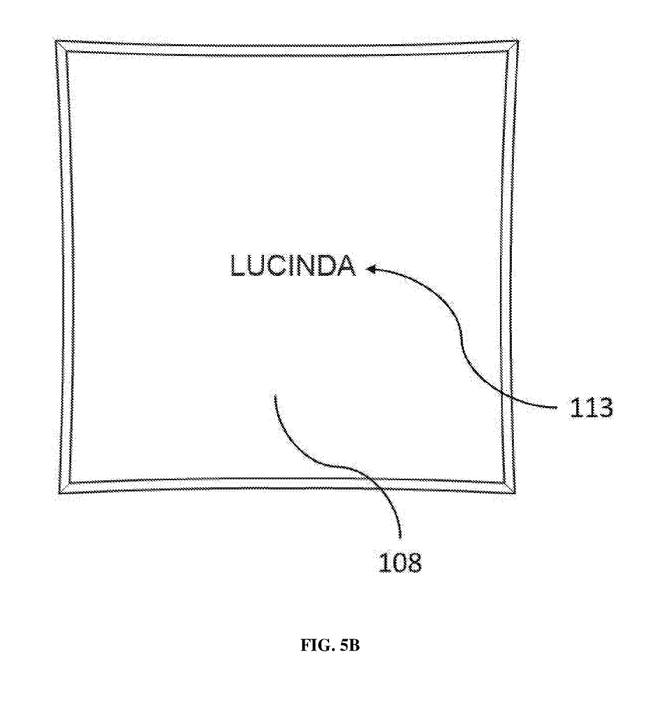

### DETAILED DESCRIPTION

In accordance with the present invention, there is provided a method for transferring an image 113 to a solid substrate 108 (e.g. glass or ceramic objects). The process of this invention is applicable to both ceramic substrates (such as, e.g., substrates comprised of glass, porcelain, ceramic whitewares, metal oxides, clays, porcelain enamel coated substrates and the like) and non-ceramic substrates (such as, e.g., substrates comprised of polymers, thermoplastics, elastomers, thermosets, organic coatings, films, composites, sheets and the like). In one preferred embodiment, the substrate 108 used is a ceramic substrate.

As used herein, the term “irregular” refers to a surface that is not flat but curved in one or more areas. Such surfaces do not lend themselves easily to transferring of colorants with dye sublimation because of their uneven surfaces and the need for direct contact between the colorants and the surface of the substrate 108.

As used herein, the “paper” carrying the colorants may be any suitable carrier capable of retaining the colorants to be transferred to the surface of the substrate 108. Suitable carriers include cellulosic and polymeric films.

As used herein, the terms “colorant” and “dye” are interchangeable and refer to the ink that is transferred to the substrate 108 during dye sublimation.

As used herein, the term “ceramic” includes glass, conventional oxide ceramics, and non-oxide ceramics (such as carbides, nitrides, etc.). When the ceramic material is glass, in one aspect, such glass is preferably float glass made by the float process. See, e.g., pages 43 to 51 of “Commercial Glasses,” published by The American Ceramic Society, Inc. (of Columbus Ohio) in 1984 as “Advances in Ceramics, Volume 18.”

The ceramic substrate used in the process of this invention, in one embodiment, preferably is a material that is subjected to a temperature of at least about 200° C., at least about 250° C., at least about 300° C., at least about 350° C., at least about 400° C., at least about 450° C., at least about 500° C., at least about 550° C., at least about 600° C., at least about 650° C., at least about 700° C., at least about 750° C., or at least about 800° C. during processing and, in one aspect of this embodiment, comprises one or more metal oxides. In one embodiment, the ceramic substrate is subjected to a temperature of at least about 550° C. during processing. Typical of such preferred ceramic substrates are, e.g., glass, ceramic whitewares, enamels, porcelains, etc. Thus, by way of illustration and not limitation, one may use the process of this invention to transfer and fix color images onto ceramic substrates such as dinnerware, outdoor signage, glassware, imaged giftware, architectural tiles, architectural glass, window glass, color filter arrays, floor tiles, wall tiles, perfume bottles, wine bottles, beverage containers, and the like.

In one implementation, the disclosure provides an apparatus for transferring an image 113 on a substrate 108 with an irregular surface using dye sublimation, the apparatus comprising: an autoclavable envelope bag 101 comprising a sealable opening 102 and a first port 103; a breather material 106 to hold in place a paper 107 carrying colorants forming the image 113 on the irregular surface; a hollow metal receptacle 109 comprising a second port 104 that connects with the first port 103 on the autoclavable envelope bag 101, a third port 105 that connects to a vacuum pump 110, and a valve 111 that opens and closes the third port 105; and a vacuum pump 110 with a tube 112 that connects with the third port 105 on the hollow metal receptacle 109.

In certain aspects, the hollow metal receptacle 109 maintains a vacuum within the autoclavable envelope bag 101 during the heating required for dye sublimation and the vacuum provides pressure that allows transfer of the colorants from the paper 107 to the irregular surface on the substrate 108.

In some aspects, the hollow metal receptacle 109 is made of one or more metals selected from the group consisting of aluminum, copper, zinc, iron, stainless steel, brass, and alloys thereof.

In other aspects, the breather material 106 comprises a material selected from the group consisting of polyester felt, coarse woven cotton, and fiberglass cloth.

In yet other aspects, the autoclavable envelope bag 101 comprises a flexible substance selected from the group consisting of a rubber, a rubber-coated fabric, and a polymer film. In one embodiment, the rubber is silicone rubber.

In some embodiments, the substrate 108 is a ceramic substrate. In one embodiment, the ceramic substrate is selected from the group consisting of a glass, a conventional oxide ceramic, and a non-oxide ceramic.

The present disclosure also provides a method of printing an image 113 on a substrate 108 with an irregular surface using dye sublimation, the method comprising: a) inserting the substrate 108 with the irregular surface into an autoclavable envelope bag 101 comprising a sealable opening 102 and a first port 103; b) placing a paper 107 carrying colorants forming the image 113 on the irregular surface with the colorants in physical contact with the irregular surface; c) covering the paper 107 and the substrate 108 with a breather material 106 to hold in place the paper 107 carrying colorants forming the image 113 on the irregular surface; d) sealing the autoclavable envelope bag 101 and connecting the first port 103 to a second port 104 on a hollow metal receptacle 109, wherein the metal receptacle 109 comprises the second port 104 that connects with the first port 103 on the autoclavable envelope bag 101, a third port 105 that connects to a vacuum pump 110, and a valve 111 that opens and closes the third port 105; e) opening the valve 111 and applying a vacuum across the hollow metal receptacle 109 and the autoclavable envelope bag 101; f) closing the valve 111 and disconnecting the third port 105 on the hollow metal receptacle 109 from the vacuum pump 110; and g) applying heat to the autoclavable envelope bag 101 containing the substrate 108 with the irregular surface in contact with the paper 107 carrying colorants to cause dye sublimation and binding of the colorants to the irregular surface.

In one aspect, the heat is applied at a temperature above the sublimation temperature of the colorants and the glass transition temperature (Tg) of the substrate 108. In another aspect, the heat is applied with an oven 114 or an autoclave.

In yet another embodiment, the apparatus comprises a vacuum to increase the pressure in the process. The exemplary vacuum may be created by enclosing the substrate 108 with an irregular surface in a vacuum bag system comprising an autoclavable envelope bag 101 and a hollow metal receptacle 109. The applied vacuum can range from about 1 to about 30 inches of mercury (Hg). Once the vacuum has been applied, the valve 111 on the hollow metal receptacle 109 is closed and the vacuum pump 110 is disconnected from the hollow metal receptacle 109 and adjoining autoclavable envelope bag 101. Implementing a vacuum is beneficial to assist in the sublimation colorant into the substrate 108, to lower the temperature at which sublimation colorant transfer occurs, to remove any trapped air or bubbles from the materials, and to prevent oxidization at higher temperatures. If appropriate, the substrate 108 may be exposed to ultraviolet or electron beam radiation to cure or set curable tints or dyes.

In another embodiment, a vacuum autoclave process is used to transfer the image 113 to the substrate 108 using a process comprised of vacuum, heat and pressure. Such autoclave processes have been used for laminating thermoplastic films to glass and are described in U.S. Pat. Nos. 3,933,552 and 4,624,731. The content of each of the aforementioned patents is hereby incorporated by reference.

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth and as follows in the scope of the appended claims.

1. An apparatus for transferring an image onto a substrate with an irregular surface using dye sublimation, the apparatus comprising:
an autoclavable envelope bag comprising a sealable opening and a first port;
a breather material to hold in place a paper carrying colorants forming the image on the irregular surface;
a hollow metal receptacle comprising a second port that connects with the first port on the autoclavable envelope bag, a third port that connects to a vacuum pump, and a valve that opens and closes the third port; and
a vacuum pump with a tube that connects with the third port on the hollow metal receptacle.

2. The apparatus of claim 1, wherein the hollow metal receptacle maintains a vacuum within the autoclavable envelope bag during the heating required for dye sublimation and the vacuum provides pressure that allows transfer of the colorants from the paper to the irregular surface on the substrate.

3. The apparatus of claim 1, wherein the breather material comprises a material selected from the group consisting of polyester felt, coarse woven cotton, and fiberglass cloth.

4. The apparatus of claim 1, wherein the autoclavable envelope bag comprises a flexible substance selected from the group consisting of a rubber, a rubber-coated fabric, and a polymer film.

5. The apparatus of claim 4, wherein the rubber is silicone rubber.

6. The apparatus of claim 1, wherein the substrate is a ceramic substrate.

7. The apparatus of claim 6, wherein the ceramic substrate is selected from the group consisting of a glass, a conventional oxide ceramic, and a non-oxide ceramic.

8. A method of transferring an image on a substrate with an irregular surface using dye sublimation, the method comprising:
a) inserting the substrate with the irregular surface into an autoclavable envelope bag comprising a sealable opening and a first port;
b) placing a paper carrying colorants forming the image on the irregular surface with the colorants in physical contact with the irregular surface;
c) covering the paper and the substrate with a breather material to hold in place the paper carrying colorants forming the image on the irregular surface;
d) sealing the autoclavable envelope bag and connecting the first port to a second port on a hollow metal receptacle, wherein the metal receptacle comprises the second port that connects with the first port on the autoclavable envelope bag, a third port that connects to a vacuum pump, and a valve that opens and closes the third port;
e) opening the valve and applying a vacuum across the hollow metal receptacle and the autoclavable envelope bag;
f) closing the valve and disconnecting the third port on the hollow metal receptacle from the vacuum pump; and
g) applying heat to the autoclavable envelope bag containing the substrate with the irregular surface in contact with the paper carrying colorants to cause dye sublimation and binding of the colorants to the irregular surface.

9. The method of claim 8, wherein the heat is applied at a temperature above the sublimation temperature of the colorants and the glass transition temperature (Tg) of the substrate.

10. The method of claim 9, wherein the heat is applied with an oven or an autoclave.

11. The method of claim 8,
wherein the hollow metal receptacle maintains a vacuum within the autoclavable envelope bag during the heating required for dye sublimation and the vacuum provides pressure that allows transfer of the colorants from the paper to the irregular surface on the substrate.

12. The method of claim 8,
wherein the breather material comprises a material selected from the group consisting of polyester felt, coarse woven cotton, and fiberglass cloth.

13. The method of claim 8,
wherein the autoclavable envelope bag comprises a flexible substance selected from the group consisting of a rubber, a rubber-coated fabric, and a polymer film.

14. The method of claim 13, wherein the rubber is silicone rubber.

15. The method of claim 8,
wherein the substrate is a ceramic substrate.

16. The method of claim 15, wherein the ceramic substrate is selected from the group consisting of a glass, a conventional oxide ceramic, and a non-oxide ceramic.
